(19) United States
(12) Patent Application Publication
(10) Pub. No.: US 2012/0032633 A1
(43) Pub. Date: Feb. 9, 2012

(54) TRANSMISSION OF POWER BIDIRECTIONALLY AND WITHOUT CONTACT TO CHARGE ELECTRIC VEHICLES

(76) Inventors: Ralf Cordes, Erlangen (DE); Gerd Griepentrog, Gutenstetten (DE); Thomas Komma, Ottobrunn (DE); Sebastian Nielebock, Balersdorf (DE)

(21) Appl. No.: 13/263,687

(22) PCT Filed: Apr. 6, 2010
(86) PCT No.: PCT/EP2010/054496

§ 371 Date: Oct. 7, 2011

(30) Foreign Application Priority Data
Apr. 9, 2009 (DE) 10 2009 016 823.0

(51) Int. Cl. H02J 7/02

(52) U.S. Cl. 320/108

(57) ABSTRACT

A converter that feeds an electric drive in an electric vehicle is used to transmit energy to the vehicle without contact using resonant operation for inductive transmission of energy. The leakage inductance of the transformer is resonantly adjusted by a serial capacitor. The load current is then switched at zero-crossing.

### CROSS REFERENCE TO RELATED APPLICATIONS

This application is the U.S. national stage of International Application Ser. No. PCT/EP2010/054496, filed Apr. 6, 2010 and claims the benefit thereof. The International Application claims the benefits of German Application No. 10 2009 016 823.0 filed on Apr. 9, 2009, both applications are incorporated by reference herein in their entirety.

### BACKGROUND

Electric vehicles are usually connected to the power supply system or to a stationary charging rectifier by plug connectors. If a battery is intended to be charged with 20 kWh within 15 minutes (what is known as 6 C charging), charging powers of approximately 87 kW can be expected, this corresponding to a current of 125 A on the 400 V power supply system. This requires the largest commercially available plug with a diameter of 126 mm and a length of 282 mm. The manual forces required for connection and disconnection amount to a few 100 N, this making operation considerably more difficult. Even higher charging powers cannot be transmitted with currently available plug systems. In addition, plug systems are susceptible to soiling and an increased contact resistance as a result of corrosion, together with a corresponding risk of overheating. An alternative which avoids these problems is the transmission of energy to the vehicle in a contact-free manner.

### SUMMARY

Described below is an apparatus for transmitting power for charging electric vehicles in a contact-free manner, the apparatus having a simplified design. In addition, an improved charging method for an energy storage device of an electrically operated vehicle is described.

The operating arrangement described below for use in an electrically operated vehicle which has at least one electric drive and at least one energy storage device for feeding electrical energy to the electric drive includes:

a converter which can be connected to the energy storage device at the input end and is designed to convert an input-end DC voltage into an output-end single- or polyphase AC voltage and to convert an output-end single- or polyphase AC voltage into an input-end DC voltage,

a coil arrangement for the inductive transmission of electrical energy,

a capacitance which is connected in series with the coil arrangement for resonance tuning.

A first switching device may be provided at the output end of the converter, for connecting the converter to the electric drive and a second switching device may be provided at the output end of the converter, for connecting the converter to the coil arrangement.

In this case, the converter which is present in the electrically operated vehicle in any case is therefore advantageously also used for the inductive transmission of electrical energy and for charging the battery. To this end, it is expedient to disconnect the converter from the vehicle motor using the first switching device and to connect the converter to the transmitter for inductive energy transmission using the second switching device when inductive transmission is intended to take place. At other times, the converter is connected to the vehicle motor by the first switching device and disconnected from the transmitter using the second switching device.

Converters for actuating electrical machines are expediently designed as hard-switching power converter circuits which commutate the motor current within a half-bridge between the two semiconductor switches, for example insulated gate bipolar transistors (IGBTs), or the associated freewheeling diodes. In order to reduce the switching losses, the switching frequency of a drive power converter of this kind is set in the kHz range, in particular to approximately 8 to 10 kHz. The switching losses are therefore approximately equal to the losses caused by the conduction of power in the semiconductors. Since the power which can be transmitted in an inductive energy transmission operation is proportional to the frequency given a defined cross section of the flux-carrying components (iron circuit, ferrites etc.), the maximum possible transmission frequency should be selected. Frequencies of between 20 and 30 kHz are advantageously used for inductive energy transmission, with ferrites then being used for carrying flux. When the converter is intended to be hard-switched at approximately 3 times the switching frequency compared to operation of the electric motor with approximately the same current, approximately double the losses would then be produced overall, this leading to thermal overloading of the power semiconductors.

Therefore, a resonant circuit is advantageously indicated for inductive energy transmission by the leakage inductance of the coil arrangement being resonantly adjusted by a capacitance which is connected in series. As a result, the load current can advantageously be switched at the zero crossing in each case. Only the magnetization current of the coil arrangement has to be subjected to hard-commutation. The resonant circuit which is formed by the leakage inductances and resonant capacitors is excited by the converter with a square-wave voltage with a frequency which corresponds to the resonant frequency.

The resonant capacitors can alternatively be provided on both sides of the transmitter or only on one side of the transmitter. If only one resonant capacitor is used, it can be arranged on the vehicle or on the charging station.

The transmitter, which performs contact-free transmission of the energy and includes the coil arrangement, can be designed in the form of a single-phase or a three-phase transmitter.

The converter may have three half-bridges, two of the half-bridges being connected to the second switching device at the output end, while the third half-bridge can be connected to the energy storage device via a DC/DC converter. As an alternative, the converter has four half-bridges, three of the half-bridges being connected to the second switching device at the output end, while the fourth half-bridge can be connected to the energy storage device via a DC/DC converter.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a circuit diagram of a first variant embodiment with a single-phase transmitter,

FIG. 2 is a circuit diagram of a second variant embodiment with a single-phase transmitter and a single-phase converter,

FIG. 3 is a circuit diagram of a third variant embodiment with a single-phase transmitter and a DC/DC converter between the battery and the converter, and

FIG. 4 is a circuit diagram of a fourth variant embodiment with a three-phase transmitter and a DC/DC converter between the battery and the converter.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

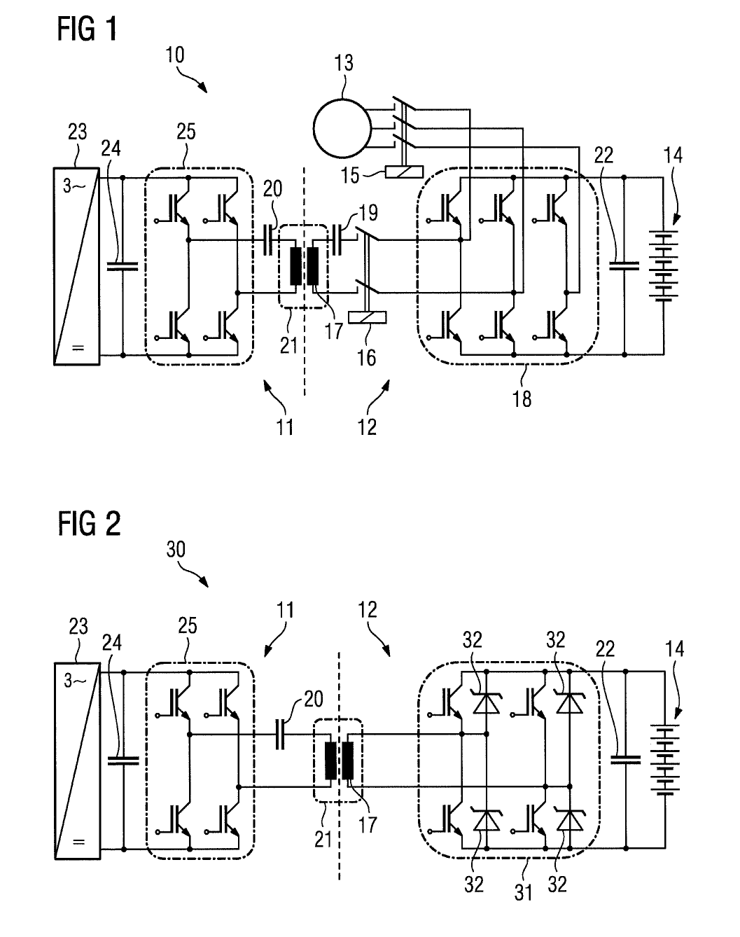

FIG. 1 shows a first complete system 10 which is made up of vehicle-side elements 12 and of stationary elements 11 and includes a first exemplary embodiment of the charging system. The stationary elements 11 are located outside the vehicle, for example beneath the vehicle, when the vehicle is in a charging station.

The vehicle-side elements 12 include an electric motor 13 for driving the vehicle, a battery 14, a converter 18, an intermediate circuit capacitor 22, a first switching arrangement 15, a second switching arrangement 16, a coil arrangement 17 as a vehicle-side part of a transmitter 21, and a vehicle-side resonant capacitor 19.

The stationary elements 11 include a rectifier 23, a stationary-side intermediate circuit capacitor 24 and a stationary-side converter 25. The stationary elements 11 also include a stationary-side resonant capacitor 20 and the stationary-side part of the transmitter 21.

In order to charge the battery 14 of the vehicle, the rectifier 23 converts the three-phase voltage of the power supply system into a DC voltage which is converted by the stationary-side converter 25 into a suitable AC voltage. The transmitter 21 ensures that the AC voltage is forwarded to the vehicle-side circuit. To this end, the connection of the converter 18 to the transmitter 21 is established by the second switch arrangement 16. At the same time, the connection between the converter 18 and the electric motor 13 is interrupted by the first switch arrangement 15.

In the first exemplary embodiment, the DC intermediate circuit, that is to say the intermediate circuit capacitor 22 of the converter 18, is substantially directly connected to the battery 14 during the charging process. As a result, the intermediate circuit voltage level of the converter 18 is determined by the state of charge of the battery 14. The vehicle transmits the desired charging power, which can also be negative, by radio or likewise by inductive or capacitive transmission to the stationary-side converter 25 or to the controller of the converter. The converter or controller then adjusts the flow of power to the desired value by tracking the setpoint value for its intermediate circuit voltage.

In the first exemplary embodiment, the resonant capacitors 19, 20 are tuned to the transmitter 21 such that a resonant circuit frequency of 25 kHz is produced. In contrast, the switching frequency of the converter 18 for motor operation is 10 kHz in this example.

FIG. 2 shows a second complete system 30 of a second exemplary embodiment of the charging system. In contrast to the first complete system 10, the vehicle-side converter 31 includes two, rather than three, half-bridges. Furthermore, Schottky diodes 32 are connected in parallel to the semiconductor switches of the converter 31. Finally, no resonant capacitor 19 is used on the vehicle side in the second exemplary embodiment.

In the case of unidirectional energy transmission, the converter 31 can be passively switched and the parallel Schottky diodes 32 can be used as passive rectifiers. This reduces the conduction losses of the converter 31. This ensures reliable charging of the battery 14 in the event of failure of the converters 31, 25 to synchronize. This variant can be realized both with a single-phase and with a three-phase transmitter 21, 73.

In order to ensure resonant operation in such a way that the power semiconductors always switch at the zero crossing of the load current, the two power converters expediently switch in a completely synchronized manner. This can be realized, for example, with an additional unloaded winding or a transformer. Phase-locked loop (PLL) or digital implementation ensures the synchronization of the two converters 18, 31, 71, 25.

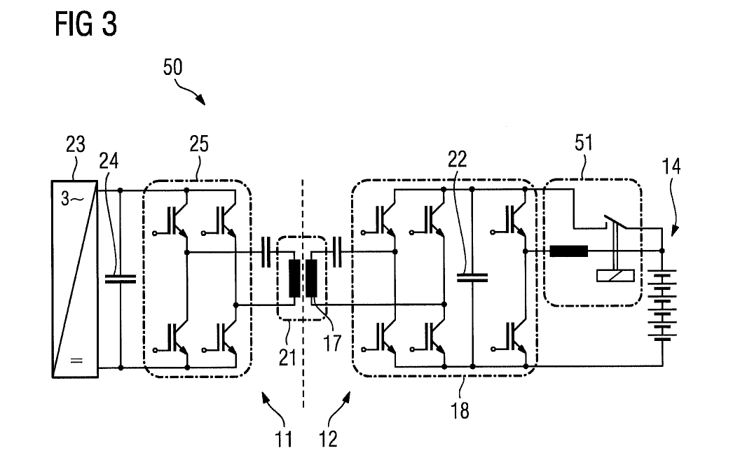

FIG. 3 shows a third complete system 50 of a third exemplary embodiment of the charging system. In the third exemplary embodiment, the vehicle-side converter 18 has three half-bridges. However, in contrast to the first two exemplary embodiments, a DC/DC converter 51 is provided between a connection of the battery 14 and the converter 18. In the third exemplary embodiment, the flow of power is controlled by adjusting the voltage of the DC intermediate circuits of the two power converters in the following manner:

In the case of a single-phase transmitter 21, only two half-bridges are required for actuation purposes on the vehicle-side and the stationary side in each case. In this case, the third half-bridge in the vehicle is used to connect the battery 14 to the intermediate circuit by a bidirectional buck-boost converter, the DC/DC converter 51, with an additional controller inductor also being required. In this case, the intermediate circuit voltage of the vehicle-side converter 18 is increased to a level above the final charge voltage of the battery 14. The flow of power is controlled by slightly changing the intermediate circuit voltage in the vehicle-side converter 18 by the outflow of power from the intermediate circuit to the battery 14 being correspondingly adjusted. If less power is output to the battery, the voltage in the intermediate circuit increases automatically, as a result of which the voltage ratio between the stationary side and the vehicle side changes, this once again reducing the transmitted power.

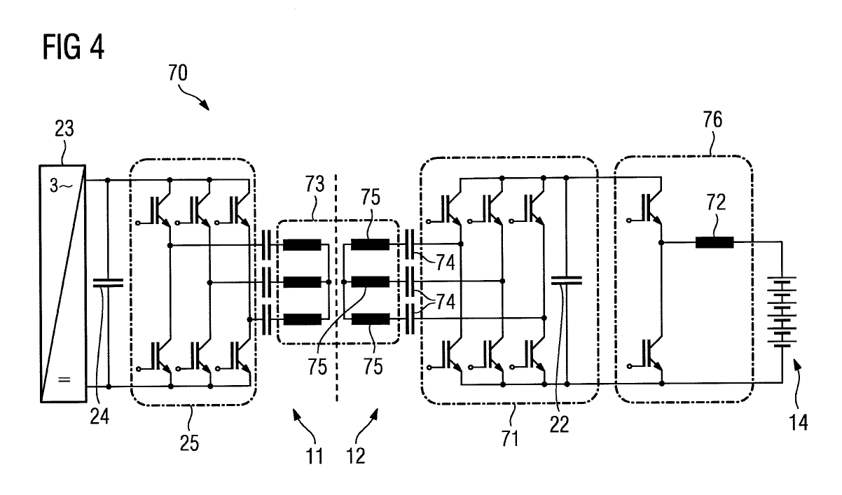

FIG. 4 shows a fourth complete system 70 of a fourth exemplary embodiment of the charging system. In contrast to the first three exemplary embodiments, a three-phase transmitter 73 is used in the fourth exemplary embodiment. In this case, resonance tuning is also performed on the vehicle side using three vehicle-side resonant capacitors 74. If a three-phase transmitter is used, three half-bridges are required both on the stationary side and on the vehicle side in each case. In this case, a fourth half-bridge is provided on the vehicle side, the fourth half-bridge taking on the functionality of the DC/DC converter 76 and connecting the battery 14 to the intermediate circuit of the vehicle-side converter 71. As an alternative, this fourth half-bridge can be used as a protective module in the normal driving mode, that is to say when the converter 71 feeds a synchronous machine which exhibits permanent-magnet excitation

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-8. (canceled)

9. A system in an electrically operated vehicle having at least one electric drive and at least one energy storage device, comprising:
an AC/DC converter, switchably connected to the at least one energy storage device at an input end, converting a first direct current voltage at the input end into a first alternating current voltage at an output end and converting a second alternating current voltage at the output end into a second direct current voltage at the input end;
a coil arrangement providing inductive transmission of electrical energy; and
a capacitance, connected in series between the coil arrangement and the AC/DC converter, providing resonance tuning of alternating current frequency.

10. The system as claimed in claim 9, wherein the capacitance and the coil arrangement are matched to produce a resonant circuit frequency between 15 kHz and 50 kHz.

11. The system as claimed in claim 10, further comprising:
a first switching device at the output end of the AC/DC converter, connecting the AC/DC converter to the electric drive; and
a second switching device at the output end of the AC/DC converter, connecting the AC/DC converter to the coil arrangement.

12. The system as claimed in claim 11, wherein the AC/DC converter has three half-bridges with two of the half-bridges connected to the coil arrangement at the output end.

13. The system as claimed in claim 11, wherein the AC/DC converter has four half-bridges with three of the half-bridges connected to the coil arrangement at the output end.

14. The system as claimed in claim 13, further comprising a DC/DC converter connected to the at least one energy storage device and connected to and/or sharing parts with the AC/DC converter.

15. A method for charging an energy storage device of an electrically operated vehicle having at least one electric drive supplied with electric energy from the energy storage device, comprising:
transmitting electrical energy to the electrically operated vehicle through inductive transmission in a contact-free manner using an AC/DC converter in the electrically operated vehicle, the AC/DC converter also supplying the electric drive with electricity when the electrically operated vehicle is driven; and
switching semiconductor switches of the AC/DC converter at zero crossing of a load current by a resonant circuit including a capacitance in the electrically operated vehicle.

16. The charging method as claimed in claim 15, further comprising increasing an intermediate circuit voltage of the AC/DC converter, in a DC/DC converter connected between the AC/DC converter and the energy storage device, to a value greater than a final charge voltage of the energy storage device.
